(19) United States
(12) Patent Application Publication
(10) Pub. No.: US 2011/0235029 A1
(43) Pub. Date: Sep. 29, 2011

(54) PATTERN MEASURING METHOD AND PATTERN MEASURING APPARATUS

(76) Inventors: Makoto Kaneko, Kanagawa (JP); Yasuhiko Ishibashi, Kanagawa (JP)

(21) Appl. No.: 12/878,751

(22) Filed: Sep. 9, 2010

(30) Foreign Application Priority Data
Mar. 25, 2010 (JP) 2010-069798

(51) Int. Cl. G01N 21/00; G01N 23/201

(52) U.S. Cl. 356/237.2; 378/86; 378/86

(57) ABSTRACT

According to one embodiment, a pattern measuring method includes: irradiating, from a plurality of different incident directions, electromagnetic waves on a periodical structure pattern in which a plurality of patterns are periodically arrayed and partially overlap one another; detecting the electromagnetic waves scattered by the periodical structure pattern and detecting scattering profiles of the electromagnetic waves; and measuring, based on the detected scattering profiles, a pattern shape of the periodical structure pattern. Each of the different incident directions is an incident direction in which the patterns included in the periodical structure pattern do not partially overlap each other.

### CROSS-REFERENCE TO RELATED APPLICATIONS

This application is based upon and claims the benefit of priority from Japanese Patent Application No. 2010-069798, filed on Mar. 25, 2010; the entire contents of which are incorporated herein by reference.

### FIELD

Embodiments described herein relate generally to a pattern measuring method and a pattern measuring apparatus.

### BACKGROUND

In semiconductor integrated circuits, microminiaturization of circuit patterns is advanced to attain high performance. According to the microminiaturization of the circuit patterns, accuracy required for measurement of the circuit patterns is becoming stricter. In a semiconductor process in the related art, concerning a unit structure included in a periodical structure, relatively rough dimensions such as width (CD) and height (HT) of a pattern are mainly targets of management. On the other hand, according to the advance of the microminiaturization of the circuit patterns, detailed dimensions of shapes such as a sidewall angle (SWA), roundness of an upper part of the unit structure called top rounding and roundness of a lower part of the unit structure called bottom rounding also need to be strictly measured.

As technologies for precisely observing the sectional shape of a structure, for example, a scanning electronic microscope (sectional SEM), a transmission electronic microscope (TEM), an interatomic force microscope (AFM), scatterometry, and critical dimension small angle X-ray scattering (CD-SAXS) are known. Among these technologies, the CD-SAXS is suitable for measurement of a fine circuit pattern from a viewpoint that satisfactory sensitivity with respect to a fine shape can be obtained in a nondestructive and non-contact manner.

Such CD-SAXS is a method of measuring a surface shape making use of X-ray small angle scattering and is a method of irradiating an X-ray on a pattern at an elevation angle equal to or smaller than 0.4° and reconstructing a shape from interference patterns due to scattered X-rays in an elevation angle direction and an azimuth angle direction.

The sectional shape of a plane perpendicular to an incident direction of the X-ray is obtained from the measurement by the CD-SAXS. The sectional shape means a contour portion of a pattern section. The sectional shape is a function represented by shape parameters such as a pattern dimension, height, a sidewall angle, top rounding, and bottom rounding.

When a pattern shape is circular, in general, measurement in one direction or an X direction and a Y direction is necessary. When a pattern shape is elliptical, measurement in two directions of a long diameter and a short diameter of an ellipse is necessary. Therefore, it is necessary to perform the incidence of X-rays from a plurality of azimuth angles different with respect to a contact diameter and calculate the contact diameter. When elliptical patterns are arrayed without partially overlapping each other in the X direction and the Y direction, the pattern shape can be measured by the measurement in the X direction and the Y direction.

However, in the case of zigzag arrangement in which patterns partially overlap one another, the pattern shape cannot be accurately measured by the measurement in the X direction and the Y direction. It is conceivable to measure the pattern shape from all the peripheral directions. However, although measurement accuracy can be improved, measurement time increases.

For example, Japanese Patent Application Laid-Open No. 2001-153822 proposes an X-ray evaluating method including a first step of making a part or all of primary X-rays radiated from a rectangular X-ray source incident at an incident angle equal to or smaller than 5° on a surface of a measurement sample arranged in parallel to a major axis of the X-ray source and measuring an intensity distribution of the X-rays diffracted on the surface of the sample with a O-dimensional detector together with a diffraction angle 2θ to obtain an X-ray diffraction profile and a second step of rotating the measurement sample within the surface of the measurement sample a predetermined angle and repeating the first step one or more times. Long-term regularity of the sample is evaluated from a plurality of the X-ray diffraction profiles obtained in the first and second steps. However, as in the technology explained above, in Japanese Patent Application Laid-Open No. 2001-153822, when the sample has a zigzag arrangement pattern, in some case, accurate measurement cannot be performed.

### BRIEF DESCRIPTION OF THE DRAWINGS

FIG. 1A is a schematic side view of the configuration of a pattern measuring apparatus used for implementation of a pattern measuring method according to an embodiment;

FIG. 1B is a schematic top view of the configuration of the pattern measuring apparatus used for implementation of the pattern measuring method according to the embodiment;

FIG. 2 is a schematic perspective view of the configuration of a detector;

FIG. 3A is a schematic plan view of a zigzag arrangement pattern in which patterns partially overlap one another, wherein incident directions are an X direction and a Y direction;

FIG. 3B is a schematic plan view of the zigzag arrangement pattern in which the patterns partially overlap one another, wherein incident directions are incident directions in this embodiment;

FIG. 4 is a flowchart for explaining a procedure for the pattern measuring apparatus shown in FIG. 1 to measure the shape of a zigzag arrangement contact pattern 2;

FIG. 5 is a flowchart for explaining in detail processing at S3 and S4 in FIG. 4 (fitting and determination of shape parameters;

FIG. 6 is a diagram of an example of a scattering profile in an azimuth angle direction;

FIG. 7 is a diagram of an example of a scattering profile in an elevation angle direction;

FIG. 8A is a diagram for explaining an example in which a zigzag arrangement contact pattern is measured from measurement values of determined shape parameters; and

FIG. 8B is a diagram for explaining the example in which the zigzag arrangement contact pattern is measured from the measurement values of the determined shape parameters.

### DETAILED DESCRIPTION

In general, according to one embodiment, a pattern measuring method includes: irradiating, from a plurality of different incident directions, electromagnetic waves on a periodical structure pattern in which a plurality of patterns are periodically arrayed and partially overlap one another; detecting the electromagnetic waves scattered by the periodical structure pattern and detecting scattering profiles of the electromagnetic waves; and measuring, based on the detected scattering profiles, a pattern shape of the periodical structure pattern. Each of the different incident directions is an incident direction in which the patterns included in the periodical structure pattern do not partially overlap each other.

Exemplary embodiments of a pattern measuring method and a pattern measuring apparatus according to an embodiment will be explained below in detail with reference to the accompanying drawings. The present invention is not limited to the following embodiments.

A pattern measuring method and a pattern measuring apparatus according to an embodiment are a pattern measuring method and a pattern measuring apparatus for irradiating, in measuring a periodical structure pattern (e.g., a zigzag arrangement pattern) in measurement performed by making use of scattering of electromagnetic waves (e.g., X-rays), the electromagnetic waves on the periodical structure pattern from a plurality of incident directions in which patterns included in the periodical structure pattern do not partially overlap each another and measuring scattered electromagnetic waves to accurately measure the arrangement and the shape of the periodical structure pattern.

The pattern measuring method and the pattern measuring apparatus according to this embodiment adopt a method of reconstructing a pattern shape from interference patterns due to X-rays scattered in a periodical structure pattern on a semiconductor substrate. The method employing the CD-SAXS is explained as an example. The pattern measuring method according to this embodiment is suitable for semiconductor substrate measurement in a process for manufacturing a fine circuit pattern of a semiconductor, liquid crystal, or the like.

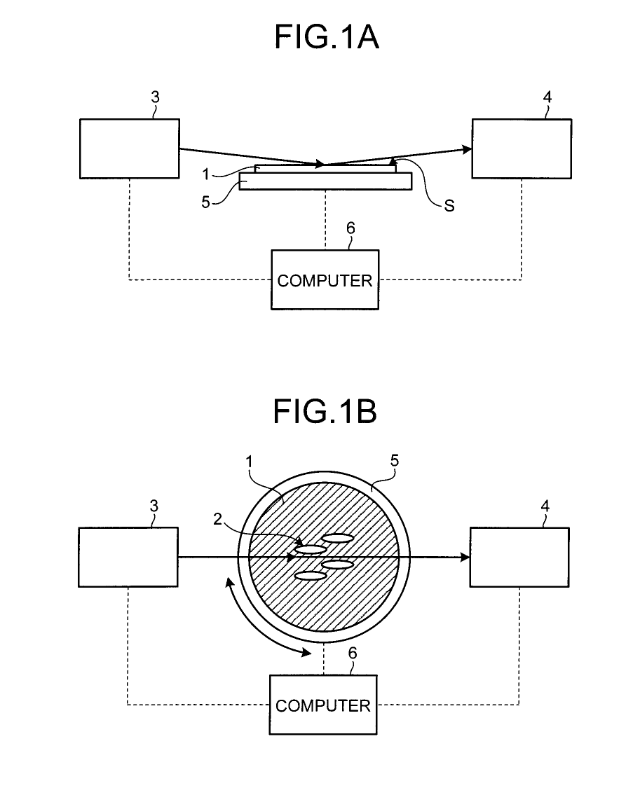

FIG. 1A is a schematic side view of the configuration of the pattern measuring apparatus used for implementation of the pattern measuring method according to this embodiment. FIG. 1B is a schematic top view of the configuration of the pattern measuring apparatus used for implementation of the pattern measuring method according to this embodiment. In FIGS. 1A and 1B, a computer 6 is schematically shown. A side configuration and a plane configuration of the computer 6 are not shown.

The pattern measuring apparatus includes, as shown in FIGS. 1A and 1B, an optical system including an X-ray source 3 and a detector 4, a stage 5 on which a semiconductor substrate 1 as a sample is placed and rotated, and the computer 6.

The semiconductor substrate 1 on which a contact pattern 2 is formed is placed on the stage 5. The contact pattern 2 includes a periodical structure pattern in which a plurality of patterns are periodically arrayed. The contact pattern 2 is, for example, a zigzag arrangement pattern (hereinafter referred to as zigzag arrangement pattern 2). A plane on which the zigzag arrangement pattern 2 is formed on the semiconductor substrate 1 is set as a reference plane S. The stage 5 is rotatable within a plane parallel to the reference plane S. A direction parallel to the reference plane S is referred to as azimuth angle direction and a direction perpendicular to the reference plane S is referred to as elevation angle direction.

The X-ray source 3 as an electromagnetic wave generation source radiates X-rays having wavelength of, for example, 0.05 nanometer to 0.5 nanometer. The X-ray source 3 functions as an electromagnetic-wave radiating unit that radiates electromagnetic waves for substrate measurement. The X-ray source 3 includes, for example, a vessel that generates Kα rays of Cu and a concave mirror that parallizes generated X-rays. The X-ray source 3 is arranged such that the X-rays are tilted at an angle equal to or smaller than, for example, 0.4 degree with respect to the reference plane S.

The computer 6 controls the operation of the X-ray source 3, the stage 5, and the detector 4, determines incident directions of the X-rays of the X-ray source 3, and rotates the stage 5. The computer 6 measures a pattern shape based on a scattering profile, which is a detection result of the detector 4.

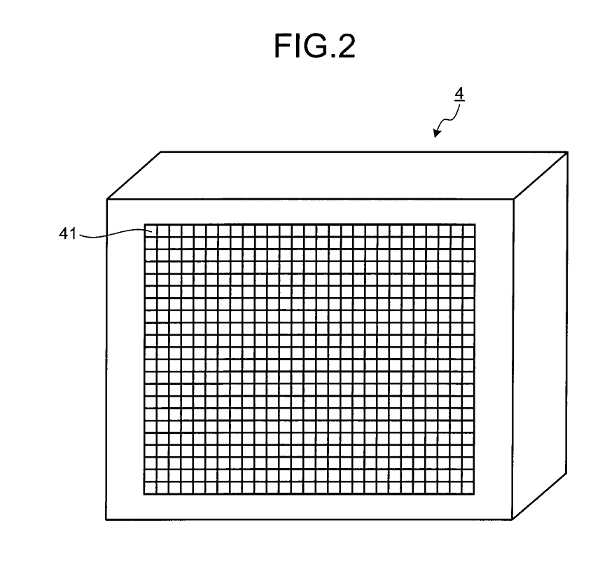

FIG. 2 is a schematic perspective view of the configuration of the detector 4. The detector 4 includes a plurality of light receiving units 41 arrayed in a two-dimensional direction. The light receiving units 41 function as detecting elements that detect X-rays. The detector 4 detects an intensity distribution of the X-rays in the two-dimensional direction. The detector 4 is arranged in a position sufficiently apart from the semiconductor substrate 1 on the stage 5 to make it possible to detect the X-rays scattering widely from the zigzag arrangement pattern 2.

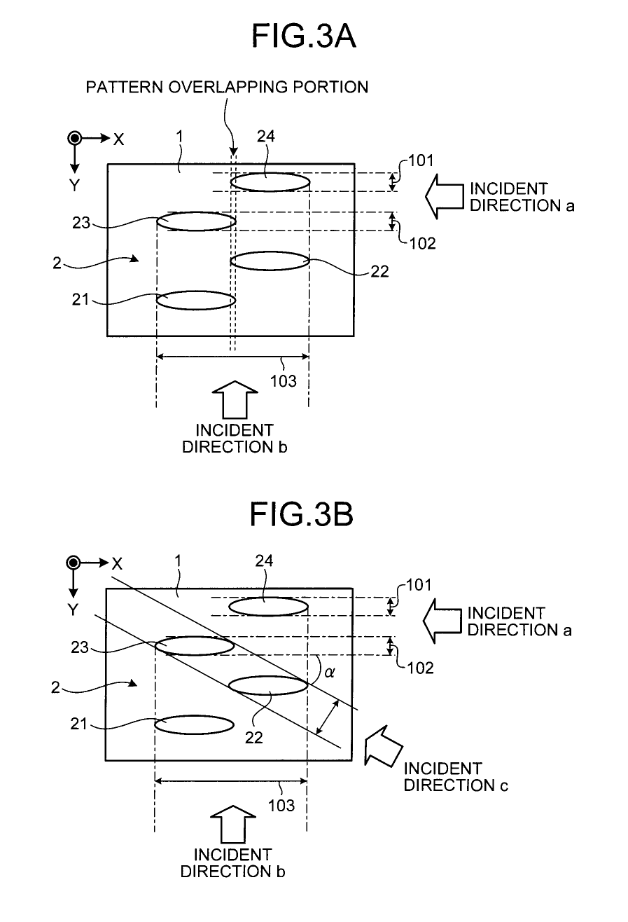

FIG. 3A is a schematic plan view of the zigzag arrangement pattern 2 in which patterns partially overlap one another, wherein incident directions are an X direction and a Y direction (incident directions in the related art). FIG. 3B is a schematic plan view of the zigzag arrangement pattern 2 in which patterns partially overlap one another, wherein incident directions are incident directions in this embodiment. Incident directions of X-rays in this embodiment in measurement of the zigzag arrangement pattern 2 are explained in comparison with those in the related art. When a pattern shape is circular, in general, measurement in one direction or two directions of the X direction and the Y direction is necessary. When a pattern shape is elliptical, measurement in two directions of a long diameter and a short diameter of an ellipse is necessary. In an example shown in FIGS. 3A and 3B, the zigzag arrangement pattern 2 in which elliptical patterns 21 to 24 are arranged in zigzag is formed on the semiconductor substrate 1.

When the elliptical patterns 21 to 24 are measured, it is a general practice to make X-rays incident from two directions of 0° (the X direction) and 90° (the Y direction) with respect to the X axis of the semiconductor substrate 1. A shape measured by the CD-SAXS is a sectional shape perpendicular to an incident direction of an X-ray. Therefore, as shown in FIG. 3A, for example, when an incident direction of an X-ray is “a” (at an angle of 0° with respect to the X axis), short diameters of the patterns 21 to 24, for example, a short diameter 101 of the pattern 21 can be measured. On the other hand, when an incident direction an X-ray is “b” (at an angle of 90° with respect to the X axis), viewed from the incident direction “b”, there is a partially overlapping portion in the patterns 21 and 22 close to each other. Width 103 including this overlapping portion is measured as pattern width. Therefore, when the two directions “a” and “b” are determined as incident directions, the shape of the zigzag arrangement pattern 2 cannot be accurately measured.

Therefore, in this embodiment, a direction in which patterns arranged in zigzag do not partially overlap each other is determined as an incident direction. The direction in which the patterns do not partially overlap each other means a direction that satisfies a condition 1: a direction in which the patterns do not overlap each other at all or a condition 2: a direction in which the patterns overlap each other only entirely (a direction in which only patterns having center points on a line connecting the center lines of the patterns overlap each other).

In FIG. 3B, the incident direction “a” is determined as an incident direction because the patterns do not overlap each other in the incident direction “a”. The incident direction “b” is not determined as an incident direction because the pattern 21 and the pattern 22 partially overlap each other in the incident direction “b” as explained above. The incident direction “c” is determined as an incident direction because the patterns do not partially overlap each other (the patterns overlap each other only entirely) in the incident direction “c”. Therefore, in this embodiment, an incident direction of an X-ray is determined as “a” and “c”.

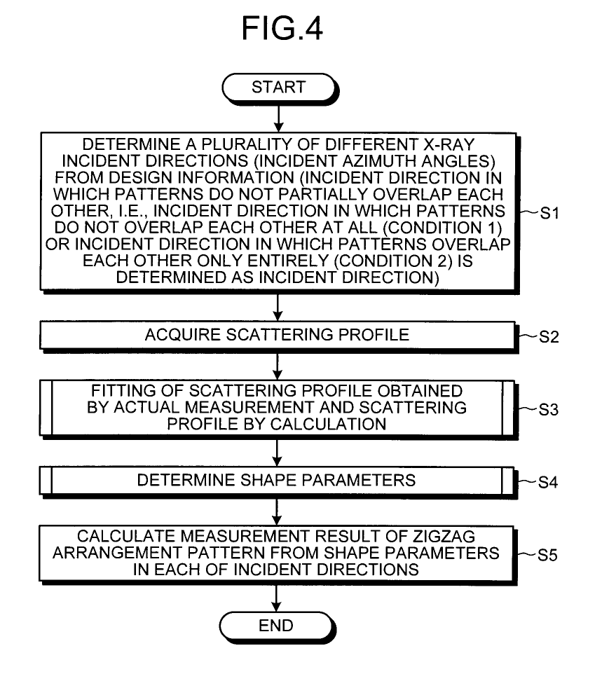

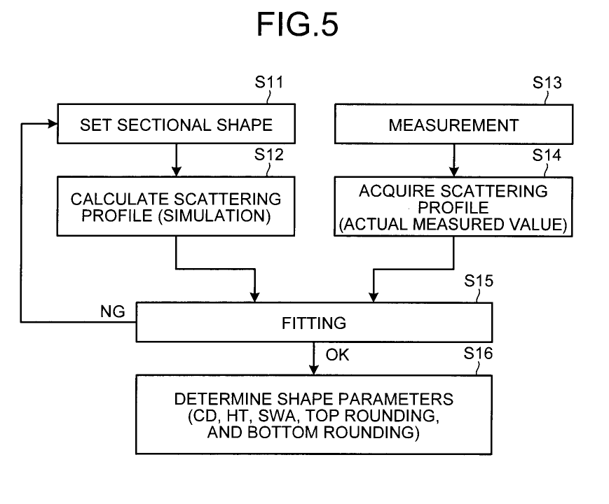

FIG. 4 is a flowchart of a procedure for the pattern measuring apparatus shown in FIG. 1 to measure a pattern shape of the zigzag arrangement pattern 2. FIG. 5 is a flowchart for explaining in detail a procedure at steps S3 and S4 (fitting and determination of shape parameters) in FIG. 4.

In FIG. 4, first, the computer 6 determines, based on design information, a plurality of different incident directions of X-rays (step S1). Specifically, as explained above, the computer 6 determines a direction in which patterns do not overlap partially each other as an incident direction, i.e., determines a direction in which patterns do not overlap each other at all (the condition 1) or a direction in which patterns overlap only entirely (the condition 2). In determining incident directions, the computer 6 determines whether the condition 1 or the condition 2 is satisfied in order of 0°, 90°, and α (0°≦α≦90° with respect to the X axis. When two angles satisfy the condition 1 or the condition 2, the computer 6 determines the two angles as incident directions, i.e., incident azimuth angles. In an example shown in FIG. 3B, 0° and α are determined as incident azimuth angles. An operator can also determine the incident azimuth angles based on design information and input the incident azimuth angles to the computer 6 or the computer 6 can also calculate the azimuth angles based on the design information by performing an arithmetic operation.

Subsequently, the computer 6 acquires, concerning a plurality of incident azimuth angles determined at step S1, actual measured values of scattering profiles on the semiconductor substrate 1 (step S2). Specifically, the computer 6 makes, while rotating the stage 5 placed on the semiconductor substrate 1, X-rays incident on the zigzag arrangement pattern 2 to change incident azimuth angles of the X-rays with respect to the zigzag arrangement pattern 2. The measurement is carried out with ranges from the determined incident azimuth angles to predetermined angles set as measurement ranges (e.g., in the example shown in FIG. 3B, a range of incident azimuth angles 0° to 10° and a range of incident azimuth angles α° to α°±10°. It is possible to acquire scattered lights under various diffraction conditions by changing the incident azimuth angles.

The detector 4 detects the X-rays reflected on the zigzag arrangement pattern 2 and scattered in the azimuth angle direction and the elevation angle direction. A two-dimensional scattering intensity image representing an intensity distribution of the X-rays is created from a result of the detection of the X-rays by the detector 4. In the light receiving units 41 of the detector 4, signal intensities by the X-rays are integrated by continuing exposure by the incident X-rays. The two-dimensional scattering intensity image of the X-rays is captured into the computer 6 every time integration time changes based on a measurement recipe and converted into intensity distributions per unit time. The computer 6 obtains a highly sensitive two-dimensional scattering intensity image concerning shape parameters of attention by adding up such intensity distributions per unit time.

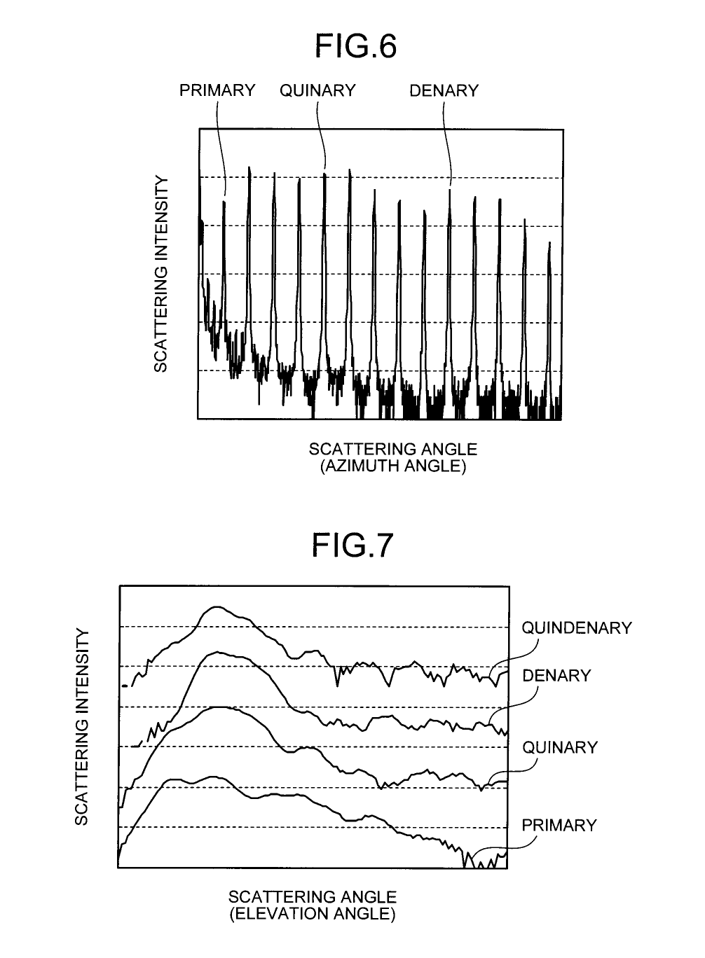

The computer 6 divides the obtained two-dimensional scattering intensity image into two-dimensional scattering intensity images in the azimuth angle direction and the elevation angle direction and calculates the two-dimensional scattering intensity images as scattering profiles in the respective directions. FIG. 6 is a diagram of an example of the scattering profile in the azimuth angle direction. The scattering profile in the azimuth angle direction represents a distribution of scattering intensity within a horizontal plane. A diffraction peak reflecting the pitch width of a pattern appears in the scattering profile in the azimuth angle direction. FIG. 7 is a diagram of an example of the scattering profile in the elevation angle direction. The scattering profile in the elevation angle direction represents scattering intensity in the vertical direction. An interference fringe reflecting the height of the pattern appears in the scattering profile in the elevation angle direction. The scattering profile in the elevation angle direction is obtained for each of diffraction peaks.

Subsequently, the computer 6 performs fitting of the scattering profile obtained as the actual measured value at step S2 and a scattering profile obtained based on a sectional shape by calculation (step S3) and determines shape parameters (step S4). Specifically, as shown in FIG. 5, the computer 6 sets a sectional shape (step S11) and calculates a scattering profile based on the sectional shape by calculation (simulation) (step S12). As explained above, the computer 6 performs measurement (step S13) and acquires a scattering profile (step S14). The computer 6 performs fitting of the scattering profile obtained as the actual measured value and the scattering profile obtained based on the sectional shape by the calculation (step S15).

Concerning the CD, the computer 6 performs fitting by the scattering profile in the azimuth angle direction. Concerning the HT, the SWA, the top rounding, and the bottom rounding, the computer 6 performs fitting by the scattering profile in the elevation angle direction. The computer 6 alternately performs the fitting by the scattering profile in the azimuth angle direction and the fitting by the scattering profile in the elevation angle direction.

When the scattering profile obtained as the actual measured value and the scattering profile obtained based on the sectional shape by the calculation coincide with each other (“OK” at step S15), the computer 6 optimizes the shape parameters. The computer 6 determines values of the optimized shape parameters as measurement values (step S16). On the other hand, when the scattering profile obtained as the actual measured value and the scattering profile obtained based on the sectional shape by the calculation do not coincide with each other (“NG” at step S15), the computer 6 sets a sectional shape with the values of the shape parameters changed (step S11) and calculates a scattering profile by simulation concerning the set sectional shape (step S12). The computer 6 performs the fitting again using the scattering profile calculated by resetting the sectional shape (step S15). The computer 6 repeats the processing until the scattering profile obtained as the actual measured value and the scattering profile obtained based on the sectional shape by the calculation coincide with each other.

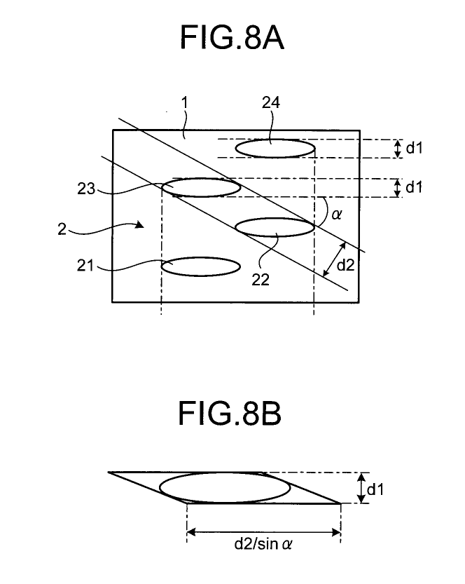

Referring back to FIG. 4, at step S5, the computer 6 calculates, based on the X-ray incident direction determined at step S1 and the measurement values of the shape parameters determined at step S4, a measurement result of the zigzag arrangement pattern 2 (step S5). FIGS. 8A and 8B are diagrams of an example in which a zigzag arrangement contact pattern is measured from a measurement value of determined shape parameters. Diameters d1 and d2 and an angle α shown in FIG. 8A are obtained as shape parameters by the measurement in this embodiment. A parallelogram shown in FIG. 8B is formed from the obtained shape parameters. The base of the parallelogram is d2/sin α and the height thereof is d1. An ellipse inscribed in the parallelogram is a measurement target pattern. In this way, it is possible to measure the shape of the zigzag arrangement pattern 2.

As explained above, according to this embodiment, X-rays are irradiated on a zigzag arrangement pattern from a plurality of incident directions in which patterns included in the zigzag arrangement pattern do not partially overlap each other, the X-rays scattered by the zigzag arrangement pattern are detected, scattering profiles of the X-rays are detected, a pattern shape is measured based on the detected scattering profiles, and a plurality of different incident directions are set in incident directions in which patterns included in a periodical structure pattern do not partially overlap each other. Therefore, it is possible to highly accurately measure the pattern shape compared with measurement performed by making the X-rays incident from the X direction and the Y direction and measure the pattern shape in a short time compared with measurement performed by making the X-rays incident from all the peripheral directions. In irradiating the X-rays on the zigzag arrangement pattern to measure the pattern shape, it is possible to highly accurately measure the pattern shape without increasing a measurement time.

An incident direction in which the patterns included in the zigzag arrangement pattern do not overlap each other is set in a direction in which the patterns do not overlap each other at all or a direction in which the patterns overlap each other only entirely. Therefore, it is possible to easily determine an incident direction.

In this embodiment, a periodical structure of a sample is not limited to the zigzag arrangement pattern and can also be any pattern that forms a periodical structure. The periodical structure can also be, for example, a two-dimensional pattern arrayed in the two-dimensional direction, a hole pattern, or the like. The pattern measuring method according to this embodiment can also be applied to a periodical structure having any pattern period. This embodiment is particularly useful for measurement of a fine periodical structure, for example, a periodical structure having a pattern period equal to or smaller than 30 nm. A pattern to be measured is not limited to the elliptical pattern and can also be other patterns. An electromagnetic wave used for substrate measurement is not limited to the X-ray and can also be an electromagnetic wave having any wavelength as long as the electromagnetic wave causes a diffraction pattern through interference of scattered light.

Shape parameters as measurement targets are not limited to those explained in this embodiment. As the shape parameters, besides the CD, the HT, the SWA, the top rounding, and the bottom rounding, for example, depth from the reference plane S can also be adopted. These shape parameters can be used for a function of a sectional shape. All the shape parameters can be selected as parameters of attention.

The parameter measuring apparatus according to this embodiment can also be applied to a system including a plurality of apparatuses (e.g., a host computer, an interface apparatus, a display, a scanner, and a printer) or can also be applied to an apparatus (a host computer) including one apparatus.

The purpose of this embodiment can also be attained by supplying a recording medium having recorded therein a program code of software for realizing the functions of the pattern measuring apparatus to a system or an apparatus and a computer (or a central processing unit (CPU), a microprocessor unit (MPU), or a digital signal processor (DSP)) of the system or the apparatus executing the program code stored in the recording medium. In this case, the program code itself read out from the recording medium realizes the functions of the pattern measuring apparatus. The recording medium having the program code or a program thereof stored therein configures the present invention. As the recording medium for supplying the program code, optical recording media, magnetic recording media, magneto-optical recording media, and semiconductor recording media such as a floppy disc (FD), a hard disk, an optical disk, a magneto-optical disk, a compact disc-read only memory (CD-ROM), a compact disc-recordable (CD-R), a magnetic tap, a nonvolatile memory, and a read only memory (ROM) can be used.

The functions of the pattern measuring apparatus are not only realized by the computer executing the read-out program code. It goes without saying that an operating system (OS) or the like running on the computer performs, based on an instruction of the program code, a part of actual processing or the entire actual processing and the functions of the pattern measuring apparatus are realized by the processing.

It goes without saying that, after the program code read out from the recording medium is written in a memory included in a function extended board inserted in the computer or a function extended unit connected to the computer, a CPU or the like included in the function extended board and the function extended unit performs, based on an instruction of the program code, a part of actual processing or the entire actual processing and the functions of the pattern measuring apparatus are realized by the processing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A pattern measuring method comprising:
irradiating, from a plurality of different incident directions, electromagnetic waves on a periodical structure pattern in which a plurality of patterns are periodically arrayed and partially overlap one another;
detecting the electromagnetic waves scattered by the periodical structure pattern and detecting scattering profiles of the electromagnetic waves; and
measuring, based on the detected scattering profiles, a pattern shape of the periodical structure pattern, wherein
in the irradiating the electromagnetic waves, each of the different incident directions is an incident direction in which the patterns included in the periodical structure pattern do not partially overlap each other.

2. The pattern measuring method according to claim 1, wherein the incident direction in which the patterns included in the periodical structure pattern do not partially overlap each other is a direction in which the patterns do not overlap each other at all or a direction in which the patterns overlap each other only entirely.

3. The pattern measuring method according to claim 1, wherein the periodical structure pattern is a zigzag arrangement pattern.

4. The pattern measuring method according to claim 1, wherein the electromagnetic waves are X-rays.

5. A pattern measuring apparatus comprising:
an irradiating unit that irradiates, from a plurality of different incident directions, electromagnetic waves on a periodical structure pattern in which a plurality of patterns are periodically arrayed and partially overlap one another;
a detecting unit that detects the electromagnetic waves scattered by the periodical structure pattern and detects scattering profiles of the electromagnetic waves; and
a measuring unit that measures, from on the detected scattering profiles, a pattern shape of the periodical structure pattern, wherein
in the irradiating unit, each of the different incident directions is an incident direction in which the patterns included in the periodical structure pattern do not partially overlap each other.

6. The pattern measuring apparatus according to claim 5, wherein the incident direction in which the patterns included in the periodical structure pattern do not partially overlap each other is a direction in which the patterns do not overlap each other at all or a direction in which the patterns overlap each other only entirely.

7. The pattern measuring apparatus according to claim 5, wherein the periodical structure pattern is a zigzag arrangement pattern.

8. The pattern measuring apparatus according to claim 5, wherein the electromagnetic waves are X-rays.
